(19) United States
(12) Patent Application Publication
(10) Pub. No.: US 2002/0167872 A1
(43) Pub. Date: Nov. 14, 2002

(54) Loading mechanism for loading and/or unloading an electronic device with more than one data memory

(76) Inventors: Norbert Kunze, Diez (DE); Stefan Mueller, Wetzlar (DE)

Correspondence Address: Corporate Patent Counsel, U.S. Philips Corporation, 580 White Plains Road, Tarrytown, NY, 10591, US

(21) Appl. No.: 10/060,496

(22) Filed: Jan. 30, 2002

(30) Foreign Application Priority Data
Feb. 1, 2001 (DE) 10104363.5

(51) Int. Cl. G11B 7/085; G11B 21/08

(52) U.S. Cl. 369/30.94

(57) ABSTRACT

The invention relates to a loading mechanism for loading and/or unloading an electronic device (1) with more than one data memory (2), which data memories are read and/or written in drives of electronic devices (1) by means of read and/or write units and have no moving parts in this respect, in which the electronic device (1) is loaded and/or unloaded via a loading opening (3), the dimensions of the loading opening (3) are adjusted to the dimensions of the data memory (2) and a transport mechanism (4) is used for transporting the data memory (2) or data memories (2) between a loading position and a play position.

The invention relates to a loading mechanism for loading and/or unloading an electronic device with more than one data memory. Another aspect of the invention relates to an electronic device for reading and/or writing of information in data memories with at least a loading mechanism according to the invention.

Data memories in the sense of the invention are data memories which can be read and/or written in drives of electronic devices by means of read and/or write units and the read and/or write units have no moving parts. Such data memories are regularly used in solid state devices. These can be both fixed location and transportable electric multimedia devices, which obtain the necessary electrical energy by means of batteries, or any other known method. Examples of solid state devices in the sense of the invention are: audio-video players, organizers, palmtops, electronic books or computers for private and business use. The data memories themselves e.g. memory cards usually have no moving parts for reading or writing information. Data memories in the sense of the invention are subject to no restrictions in their outer form and materials used.

Solid state devices or their loading mechanisms for loading and/or unloading several solid state data memories are known among other things from EP 0 744 751 A2. In the application described there for an audio player, any number of music memory cards desired by the user can be arranged horizontally on a carrier element. The carrier element can be brought in a storage unit for music memory cards from a loading position via a loading opening into a play position by means of a loading mechanism. In this play position the music memory cards are electronically connected to the audio player. If the required number of music memory cards to be arranged exceeds the number of music memory cards which can be positioned on a carrier element, an additional carrier element is used. The solution described offers only the facility of arranging carrier elements above each other in several storage units. The size of the loading opening usually corresponds to the size of the carrier element. As the number of music memory cards to be inserted increases, the number of carrier elements increases successively and hence the height of the audio player.

If several carrier elements are required, these each need at least one loading mechanism and one loading opening. Besides said equipment complexity, there are a number of applications in which only a very limited space is available for positioning of the loading opening of an electronic device e.g. in the dashboard of a motorcar. In these cases there is only space for one loading opening or a particular size of loading opening i.e. the described solution cannot be used. It is also disadvantageous that for the purpose of removing a music memory card the carrier element, with all other music memory cards arranged thereon, must be brought to the loading position. Access, in particular for reading information from the other music memory cards, is normally not possible in the loading position.

It is an object of the invention to prepare a loading mechanism of the type described in the opening paragraph which can be constructed with comparatively little equipment complexity and little space required for the loading opening. It is also an object of the invention to provide an electrical device for reading and/or writing of information in data memories which has a loading mechanism of the aforementioned type.

The object is achieved in that a loading mechanism for loading and/or unloading an electronic device with more than one data memory is produced which data memories are read and/or written in the drives of electronics devices (1) by means of known read and/or write units and have no moving parts with respect thereto, while the loading and/or unloading of the electronic device takes place via a loading opening, the dimensions of the loading opening are adjusted to the dimensions of the data memory and a transport mechanism serves to transport the data memory or data memories between the loading position and a play position.

The elements of a loading mechanism for loading and/or unloading an electronic device are known per se and described for example in DE 197 38 227 A1. A loading mechanism of the type described here has as essential elements at least one transport mechanism and one drive unit. The actual design of the loading mechanism is influenced in particular by the proposed application and the structural requirements.

The loading position is the position in which the data memory or memories directly or indirectly become connected, in particular by form closure or frictionary connection with the transport mechanism. The play position is the position of the data memory or memories in which it or they can communicate in usual manner by wire or wireless with the read and/or write unit of the electrical device. The wire connection is achieved by contact for example using conventional plug-type elements which are brought into engagement.

The loading mechanism preferably has a carrier element in which can be arranged a data memory or several data memories. The manual loading or unloading of a carrier element with data memories usually takes place in the loading position.

In a further preferred embodiment of the solution according to the invention, one or more carrier elements loaded with a data memory or several data memories are brought into the play position by a transport mechanism. The transport mechanism can then preferably be decoupled from the carrier element and is in a standby position. From this standby position it is quickly possible to reach both the loading position and a position suitable for removal of data memories from the play position.

According to an alternative preferred embodiment of the invention the data memories—without remaining in the carrier element or having been arranged in this—are brought into the play position in a magazine. The use of a magazine allows defined storage of the data memories in a small volume. In principle it is possible to transfer the data memories directly from the transport mechanism to the magazine or bring them in a suitable manner from the carrier element into the magazine.

The form and construction of the magazine can usually be adapted to the respective application. In the sense of the invention they are magazines with one or more levels for holding data memories, where the levels can be physically arranged horizontally, vertically and/or in any other manner. The data memories can be deposited in the magazine in particular as a function of the data memory form, in particular with regard to its outer contour and dimensions, and the fitting space available. The use of flexible materials, e.g. flexible foil materials, in particular for the contour-determining parts of the data memory, allows round or at least curved contours of the magazine.

Several data memories can in principle lie simultaneously in a play position in the magazine so that simultaneous reading and/or writing of several data memories is possible.

A further preferred embodiment of the invention relates to the dimensioning of the loading opening which is adjusted to the dimensioning of the data memory so that the smallest side face of the data carrier determines the dimensioning of the size of the loading opening. The size of the loading opening is determined according to the outer basic form of the data memory such as, for example, a cube or a hexahedron. The size of the loading opening should allow the easy loading and/or unloading of the electrical device and simultaneously be dimensioned as small as possible according to the spatial conditions concerned. The loading opening can in the sense of the invention be arranged horizontally, vertically or in any other way in the electrical device.

An example of embodiment of the invention is now described in more detail with reference to the drawing, which shows:

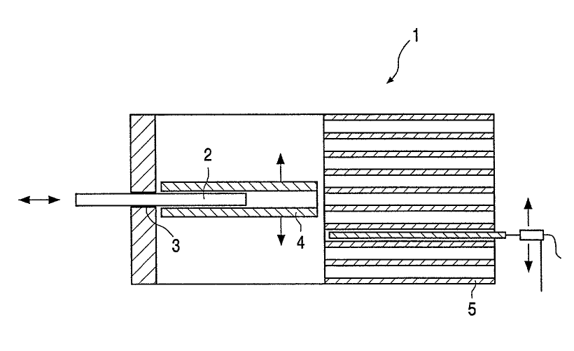

FIG. 1 shows a diagrammatic side view of an electrical device with a loading mechanism for loading and/or unloading several data memories.

FIG. 1 shows in diagrammatic form an electrical device 1, for example a stationary audio player, arranged in a dashboard of a motorcar. The disc-like data memories 2 used in the example of embodiment can be pushed in or retracted horizontally via the loading opening 3, here formed as a slot, by a transport mechanism 4. The loading opening 3 is dimensioned such that the smallest side face of the disc-like data memory 2 determines the size of the loading opening 3. This means that the shape of the loading opening 3 corresponds to the shape of the smallest side face of the data memory 2 used and is only large enough to allow at least easy loading and/or unloading.

The transport mechanism 4, which may have a customary drive unit (not shown) is arranged vertically mobile so that in the loading position it can hold or discharge a data memory 2. After the lift-like motion of the loaded transport mechanism 4 and the targeted positioning in front of an opening of the magazine 5, in which no data memory 2 resides, the data memory 2 is transferred to the magazine 5. The transport mechanism 4 in the unloaded state is in the standby position. The magazine 5 allows the horizontal insertion of one data memory 2 each time in a rack of the magazine 5, where the racks of the magazine 5 are arranged above each other. By vertical motion, preferably on one of the other three sides of the magazine 5, a contact element can be arranged at the point where, between a selected data memory 2 and the read and/or write unit of the electrical device 1, a conventional wired communication can be achieved in the play position. Alternatively a contact element can be permanently arranged on each rack of the magazine 5, so that a data memory 2 or several data memories 2 can be read and/or written, where applicable simultaneously.

1. A loading mechanism for loading and/or unloading an electronic device (1) with more than one data memory (2) which are read and/or written in drives of electronic devices (1) by means of read and/or write units and the read and/or write units have no moving parts, in which the electronic device (1) is loaded and/or unloaded via a loading opening (3), the dimensions of the loading opening (3) are adjusted to the dimensions of the data memory (2) and a transport mechanism (4) is used for transporting the data memory (2) or data memories (2) between a loading position and a play position.

2. A loading mechanism as claimed in claim 1, characterized in that one or more data memories (2) can be arranged in a carrier element.

3. A loading mechanism as claimed in claim 1, characterized in that one or more carrier elements loaded with one data memory (2) or several data memories (2) can be placed in the play position by the transport mechanism (4).

4. A loading mechanism as claimed in claim 3, characterized in that one or more carrier elements loaded with one data memory (2) or several data memories (2) are placed in a magazine (5).

5. A loading mechanism as claimed in claim 1, characterized in that the data memory or data memories (2) in the magazine (5) can be placed in the play position.

6. A loading mechanism as claimed in claim 1, characterized in that data memories (2) or carrier elements loaded with one data memory (2) or several data memories (2) can be placed on one level or on several levels in the magazine (5).

7. A loading mechanism as claimed in claim 6, characterized in that the levels in the magazine (5) are spatially arranged in horizontal, vertical and/or in an arbitrary manner.

8. A loading mechanism as claimed in claim 1, characterized in that, after loading and/or unloading, the transport mechanism (4) is in a standby position.

9. A loading mechanism as claimed in claim 1, characterized in that the dimensions of the loading opening (3) are adjusted to the dimensions of the data memory (2) so that the smallest side face of the data memory (2) determines the dimensioning of the size of the loading opening (3).

10. Electronic device for reading and/or writing information on data memories (2) with at least one loading mechanism as claimed in one of the claims 1 to 9.
